(19) United States
(12) Patent Application Publication
(10) Pub. No.: US 2025/0254049 A1
(43) Pub. Date: Aug. 7, 2025

(54) STATEFUL SIGNATURES

(71) Applicant: Hewlett-Packard Development Company, L.P., Spring, TX (US)

(72) Inventors: Thalia May Laing, Bristol (GB); Maugan Cedric Villatel, Bristol (GB)

(73) Assignee: Hewlett-Packard Development Company, L.P., Spring, TX (US)

(21) Appl. No.: 18/854,924

(22) PCT Filed: Apr. 28, 2022
(86) PCT No.: PCT/US2022/071976

§ 371 Date: Oct. 7, 2024

(51) Int. Cl. H04L 9/32

(52) U.S. Cl. CPC H04L 9/3247; H04L 9/3228

(57) ABSTRACT

In an example, a computing device is described. The computing device comprises a processor. The processor is to identify a partition in a state space of a stateful signature scheme for implementation by a cryptoprocessor; and provide, to the cryptoprocessor, an indication of the partition.

### BACKGROUND

A cryptoprocessor may use a private key to sign data. A verifier may use a public key associated with the private key to verify that the data was signed by the cryptoprocessor.

### BRIEF DESCRIPTION OF DRAWINGS

Non-limiting examples will now be described with reference to the accompanying drawings, in which:

FIG. 1 is a simplified schematic drawing of an example computing device for implementing a stateful signature scheme;

FIG. 2 is a flowchart of an example method of implementing a stateful signature scheme;

FIG. 3 is a simplified schematic drawing of an example Merkle tree for implementing a stateful hash-based signature scheme;

FIG. 4 is a simplified schematic drawing of example computing devices for implementing a stateful signature scheme;

FIG. 5 is a simplified schematic drawing of an example computing device for implementing a stateful signature scheme;

FIG. 6 is a simplified schematic drawing of an example computing device for implementing a stateful signature scheme;

FIG. 7 is a simplified schematic drawing of an example computing device for implementing a stateful signature scheme;

FIG. 8 is a flowchart of an example method of implementing a stateful signature scheme; and

FIG. 9 is a simplified schematic drawing of example computing devices for implementing a stateful signature scheme.

### DETAILED DESCRIPTION

Disclosed herein are computing devices, machine readable media and methods for implementing a stateful signature scheme.

In some examples, a computing device may comprise a cryptoprocessor (e.g., a signer) to perform a cryptographic operation such as signing data with a private key, encrypting data, etc. A cryptoprocessor may implement a level of security that specifies whether the cryptoprocessor is to do anything with data stored therein (e.g., keying material) in response to an event such as a physical attack on the cryptoprocessor. The level of security specified for the cryptoprocessor may depend on the use case of the cryptoprocessor. For example, computing infrastructure for high security priority applications such as deploying software updates to consumer computing devices, handling enterprise or government services, etc., may use a cryptoprocessor implementing a high level of security to prevent unauthorized access to data stored therein such as keying material used for such applications. However, devices such as consumer computing devices may use a cryptoprocessor implementing a comparatively lower level of security such as some trusted platform modules (TPMs). In some examples, a cryptoprocessor implementing a high level of security may include a physical security mechanism to wipe data such as keying material from the cryptoprocessor in response to an attack. An example of such a physical security mechanism implementing a high level of security includes an electrical connection built into an enclosure of the cryptoprocessor which, when opened, breaks the electrical connection to trigger deletion (e.g., by zeroizing) of the keying material from a memory of the cryptoprocessor. In some examples, a cryptoprocessor implementing a lower level of security may include a comparatively less-sophisticated physical security mechanism. In some examples, a tamper evident seal may indicate any tamper attempts (which may be detected upon inspection of the seal). In some examples, breaking a tamper evident seal may not necessarily lead to wiping of data such as keying material. Therefore, in some examples, a tamper evident seal may be used for implementing the lower level of security.

Examples of cryptoprocessors (sometimes referred to as secure cryptoprocessors) that may implement a physical security mechanism include devices such as a cryptographic module or hardware security module (HSM). In some examples, the level of security provided by a cryptoprocessor may comply with a standard such as specified by the Federal Information Processing Standards (FIPS) Publications 140-2 or 140-3.

As used herein, a stateful signature scheme refers to use of a function (e.g., a hash function for a stateful hash-based signature scheme) to construct keys for a signature scheme. Such a signature scheme is considered stateful by virtue of the one-time signature (OTS) private keys generated under the scheme being single-use and ensuring that they are not ever re-used to sign data. Re-using a private key of a stateful signature scheme may destroy the security of the scheme.

An example stateful hash-based signature scheme uses a private seed value and a state (identified by an index value, x) that may be incremented by a counter defined by 0≤x≤2^{h}−1, to generate 2^{h} OTS private keys. From each OTS private key, an OTS public key is then computed. The OTS public keys are then combined in a Merkle tree of height h, where each OTS public key is placed at the leaf position (i.e., a node of the Merkle tree) corresponding to the state used to generate it. The root of the Merkle tree is then the public key of the system and given to the verifier (e.g., via a trusted entity). An additional description of the Merkle tree structure is given below.

In this example, to sign a message, a signer uses the current state (derived from the counter), computes a one-time signature using the relevant OTS private key, then sends the OTS signature and information (i.e., an authentication path) needed for verifying signatures e.g., via a trusted entity, to allow the verifier to verify that a candidate public key derived from the OTS signature is contained in the Merkle tree. The authentication path indicates the nodes and/or public keys contained in the Merkle tree for the stateful signature scheme to allow a root public key for the stateful signature scheme to be computed. The signer then increments the state to block the same OTS private key (or the state for generating the same OTS private key) from being used again.

The verifier receives the signed message and computes a candidate OTS public key. The verifier can then verify that the candidate OTS public key is contained in the Merkle tree with the public key as its root node. If the verification procedure is successful, the verifier accepts the signature as valid and the message as authentic.

Stateful hash-based signature schemes are predicted to be quantum secure, meaning that they are considered likely to be resistant to attacks by quantum computers. However, the fact that they are stateful, coupled with the disastrous security implications repetition of the state can have, introduces concerns around resiliency of the key. Backing up the key and state may result in state repetition and therefore a loss of security. However, not backing up the key may result in losing the key if key storage fails.

Example stateful hash-based signature schemes such as the Leighton-Micali Hash-based Signature Scheme (LMS) and the extended Merkle Signature Scheme (XMSS) specify that the signer is to maintain a state, which updates every time a signature is produced. The state is chosen from a finite set. For example, the state may be a counter which runs from 0 to 2²⁰−1 for a Merkle tree of height 20. This state is used in conjunction with a private seed value to produce a one-time signing (OTS) private key, which is used to produce a signature. If the state, and therefore the OTS key, is repeated and used to sign two distinct messages, the security of the scheme collapses. Thus, state management is a relevant consideration for maintaining the security of the scheme.

It may be necessary to prepare for the possibility that a cryptoprocessor holding the private key may fail during the key's lifetime by introducing resiliency to the system. This is relevant if the key is to be used to generate signatures over a long period of time and/or replacing the public key would be difficult.

A copy of the private key could be stored in a secure alternate location. However, in the case of stateful hash-based signatures, simply copying the private seed value and the state may create a risk of state reuse, thereby destroying the security. In an example scenario where a signer has a private seed value and state, these two values may have been backed up on an alternative device. The signer may then sign a message, increment the state and then fail, losing both the private seed value and state. The signer may then recover the key from backup, which holds the previous, non-updated state, thus resulting in state reuse next time the signer signs, resulting in loss of all security.

Thus, it remains an open problem for how to provide resiliency of a key in a stateful signature scheme whilst removing the chance of state reuse.

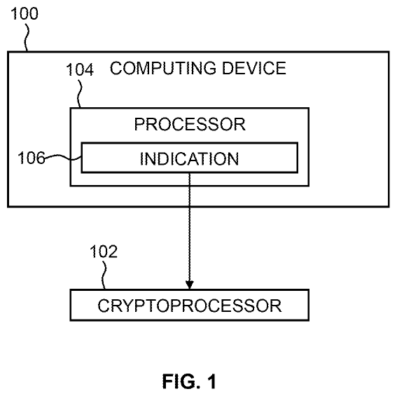

FIG. 1 is a simplified schematic drawing of an example computing device 100 for implementing a stateful signature scheme.

In some examples, the computing device 100 may implement the functionality of a signer such as an entity that may be trusted to sign data (e.g., a message digest) providing the entity has not been compromised. An example implementation may be in a server or other computing infrastructure (e.g., for providing a cloud service). Such a server or other computing infrastructure may be set up to transmit a message comprising a software or firmware update to a target device such as a user device (e.g., a laptop, phone, tablet, Internet-of-Things (IoT) device, printer or other hardware). In this example implementation, the computing device 100 may be installed in the server or other computing infrastructure to sign the message comprising the update using an OTS private key under the stateful signature scheme. Thus, the target device may receive an authentication path from the computing device 100, alongside the signature, to facilitate verification of the message.

The computing device 100 comprises a processor 104. The processor 104 is communicatively coupled to a cryptoprocessor 102. The processor 104 is to identify a partition in a state space of a stateful signature scheme (for example, a stateful hash-based signature scheme) for implementation by the cryptoprocessor 102. The state space may comprise a set of states (where each state may be indicated by an index value, as described elsewhere herein). A partition in the state space may refer to a subset of the set of states (i.e., a subset of the set of index values). Thus, identifying the partition may refer to identifying a subset of the set of states (or the corresponding index values) under the stateful signature scheme that can be used by the cryptoprocessor 102.

The processor 104 is further to provide, to the cryptoprocessor 102, an indication 106 of the partition. In some examples, the indication 106 may refer to the partition of the state space (e.g., subset of index values) identified for use by the cryptoprocessor 102 (for generating OTS private keys based on the states in the partition). In some examples, the indication 106 may refer to a rule for allowing the cryptoprocessor 102 to determine by itself the partition of the state space (e.g., subset of index values) identified for use by the cryptoprocessor 102. In the example of FIG. 1, the cryptoprocessor 102 is a separate entity to the processor 104, meaning that the cryptoprocessor 102 and the processor 104 are on different platforms to each other. In this example, the cryptoprocessor 102 may implement the functionality of a signer (using keying material stored therein) and the processor 104 may implement the functionality of identifying and assigning the partition for use by the cryptoprocessor 102. The processor 104 (and hence the computing device 100 hosting the processor 104) may not be a signer.

However, in some examples, the processor 104 may be a signer (and may therefore also implement the functionality of a cryptoprocessor 102). In such examples, the processor 104 may identify its own partition of the state space. In some examples, as described elsewhere herein, the processor 104 may identify another (different) partition of the state space for use by a second cryptoprocessor. In examples where the computing device 100 implements the functionality of a signer, the computing device 100 may implement the functionality of both the cryptoprocessor 102 and the processor 104. For example, the cryptoprocessor 102 may itself identify the partition to be used (i.e., the cryptoprocessor 102 may implement the functionality of the processor 104). In another example, a processor 104 hosted by the computing device 100 may identify the partition and provide the indication 106 of the partition to a cryptoprocessor 102 also hosted by the computing device 100.

In some examples, the processor 104 may have access to instructions (e.g., stored in a memory of the computing device 100) readable and executable by the processor 104 to implement the functionality described above. In some examples, the functionality of the computing device 100 is to identify partitions of the state space to be used by a set of cryptoprocessors (i.e., signers) under the stateful signature scheme. In some examples, the computing device 100 itself does not implement the functionality of a signer (and instead transmits the indication 106 to the cryptoprocessor 102). In some examples, the computing device 100 itself implements the functionality of a signer (i.e., the computing device 100 identifies the partition 106 (e.g., the subset of index values corresponding to the states available) for use by a cryptoprocessor 102 of the computing device 100, and the states in this partition are used by the cryptoprocessor 102 to generate private keys as described in more detail below). In some examples, the cryptoprocessor 102 is a hardware security module (HSM). In some examples, the computing device 100 is a cryptoprocessor such as an HSM (i.e., in which case, the cryptoprocessor 102 implements the functionality of the processor 104, as well as being a signer).

In some examples, a secure communication path may be needed between the partition assigner and the signers under the stateful signature scheme (e.g., to avoid a malicious entity sending malicious partitions to the signer to trick the signer into state reuse). A secure communication path between the partition assigner and the signers may prevent the signers from using an incorrect (e.g., malicious or otherwise unauthorized) partition of the state space. In an example, a secure communication path may be formed if the partition assigner signs the indication 106 with their private key and sends the signed indication 106 to the signer. The signer may then verify that the signature applied to the indication 106 is genuine by using the corresponding public key for the private key (e.g., where the public key may be verified by a certificate authority). In another example, a secure communication path may be formed if the partition assigner and the signer share a key for computing a message authentication code (MAC) such as a hash-based MAC (HMAC) for use in signing (and verifying) the indication 106. In another example, a secure communication path may be formed if the partition assigner encrypts the indication 106 with the signer's public key (if the public key is distributed in a trusted manner). Successful decryption by the signer may indicate that the indication 106 can be trusted. The secure communication path may be needed whether the partition assigning is performed by a computing device that is a signer or is not a signer.

In some examples, the partition is assigned by an entity such as a person/admin, e.g., the entity decides how to partition the state space, and a computing device under the entity's control may provide the indication 106 to the signers.

The partition in the state space may be assigned to the cryptoprocessor 102, meaning that any states in the identified partition may be used to generate OTS private keys. However, any states in the state space that are not within the partition are not assigned to the cryptoprocessor 102. In some examples, each state of the partition may be identified by an index value. An index value may be used (e.g., as an input to a key generator) to generate a corresponding OTS private key. States not in the partition may be identified by different index values to the index values that identify the states in the partition.

The computing device 100 may reduce risks associated with loss of keying material and/or knowledge about a state that has already been used for producing an OTS private key used to produce a signature if a signer (e.g., the computing device 100 itself or another signer) fails for any reason (e.g., breaks downs or becomes compromised thereby triggering its physical security mechanism). This is because the states not in the partition may still be available to another signer to use (e.g., if the computing device 100 itself fails) for generating OTS private keys, as explained in more detail below. Since these other states not in the partition are in the same state space of the stateful signature scheme, a verifier may still be able to verify any messages signed by another signer that implements the same stateful signature scheme. In other words, partitioning the state space for a signer (i.e., where a different partition of the state space is assigned to different signers) may allow one of the signers to access keying material and still be able to produce a verifiable signature, even if another signer fails, and vice versa. In some examples, key resiliency may be maintained while reducing the risk of state reuse. In some examples where the verifier is resource constrained, such as may be the case in a secure boot procedure implemented by a target device, the smaller the OTS signature, the less time is needed for signature verification.

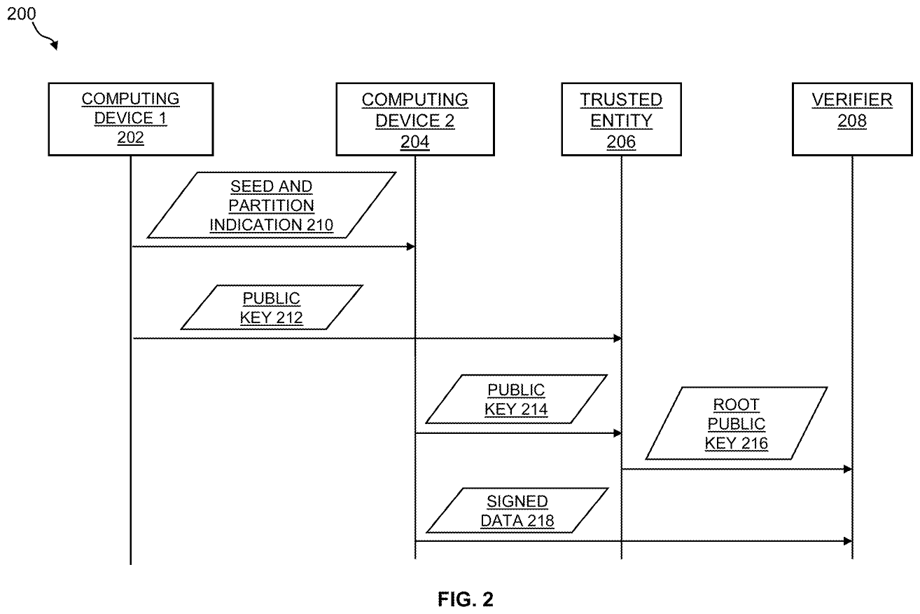

FIG. 2 is a flowchart of an example method 200 of implementing a stateful signature scheme. In some examples, a part of the method 200 may be implemented by the computing device 100 or other computing devices or machine-readable media described herein. The flowchart depicts an interaction between a first computing device (computing device 1) 202, a second computing device (computing device 2) 204, a trusted entity 206 (e.g., trusted to generate and/or store a root public key) and a verifier 208 (e.g., a user device). In some examples, the first computing device 202 implements the functionality of the computing device 100 of FIG. 1.

In use, the first computing device 202 obtains a seed (e.g., generated based on a pseudorandom function, accessed from a memory of the first computing device 202, collaboratively produced with the second computing device 204 using a key agreement protocol or otherwise obtained in any appropriate way) and identifies a (first) partition of a state space for the first computing device 202 to use. In some examples, the identification of the partition may be based on a rule such as specified below or based on other information such as external input by a user indicating which states the first computing device 202 is to use. The indication 106 referred to in FIG. 1 may indicate such a rule or external input.

In order to allow the second computing device 204 to implement the same stateful signature scheme, the first computing device 202 transmits information 210 for implementing the stateful signature scheme to the second computing device 204. In some examples, the information 210 comprises a seed (e.g., the same seed used by the first computing device 202) unless the second computing device 204 already knows the seed. Thus, the seed used by the first and second computing devices 204 may be the same or different. Whether or not the seed is the same may affect the implementation of the stateful signature scheme, as described below. Further, the information 210 comprises an indication of a (second) partition of the state space assigned to the second computing device 204. The seed (if needed) and the indication may be transmitted separately or in the same package. The indication allows the second computing device 204 to determine which states of the state space are available for use by the second computing device 204 (to generate its own set of OTS private keys).

Thus, in some examples, the OTS private keys generated by the first computing device 202 may be generated based on the states in the first partition and the seed accessible to the first computing device 202. In some examples, a corresponding public key 212 may be derived, by the first computing device 202, from the OTS private keys generated by the first computing device 202 (for example, if the first and second computing devices 202, 204 do not share the same seed).

Further, the OTS private keys generated by the second computing device 204 may be generated based on the states in the second partition and the seed accessible to the second computing device 202 (which may or may not be the same as the seed accessible to the first computing device 202). In some examples, a corresponding (second) public key 214 may be derived, by the second computing device 204, from the OTS private keys generated by the second computing device 204 (for example, if the first and second computing devices 202, 204 do not share the same seed). A root public key (for use in verifying signatures produced under the stateful signature scheme) may be generated based on the first and second public keys 212, 214, as described in more detail below.

In some examples where the first and second computing devices 202, 204 share the same seed, either of the computing devices 202, 204 could compute the root public key. In some examples, other entities may compute the root public key, as described in more detail below.

Although examples described herein refer to generating a set of OTS private keys based on a corresponding set of states, in some examples, a single state may be assigned to a computing device meaning that the computing device may sign data once under the stateful signature scheme.

According to certain examples, if one of the first or second computing devices 202, 204 fail, the other of the computing devices 202, 204 may still be used to sign data. Although two computing devices 202, 204 are described, there may be more computing devices for signing data such as three or more computing devices.

Providing the state space is partitioned into “n” distinct partitions (where the number of computing devices is “n”) and each computing device has a copy of the (private) seed and can identify their unique partition of the state space, the computing devices may be set up to implement a stateful signature scheme. When implementing such a scheme, the computing devices can use the same seed to generate OTS private keys but using the states from their partition of the state space without any concern about state re-use between them. This is subject to each computing device enforcing that it does not re-use any of its assigned states to generate any OTS private keys (e.g., by using a counter function).

Thus, according to this example, one of the computing devices (i.e., the first computing device 202) of the “n” computing devices informs (via the indication) the other computing devices about which partition of the state space they can use. Each of the computing devices obtains the same seed (according to the examples described previously).

Each computing device 202, 204 generates its unique set of OTS private keys and a corresponding public key 212, 214 derived from its set of OTS private keys, as described in more detail below.

In the depicted method 200, the first computing device 202 transmits its public key 212 to the trusted entity 206. Further, the second computing device 204 transmits its public key 214 to the trusted entity 206. The combination of the public keys 212, 214 may be used by the trusted entity 206 to construct a root public key 216 for verifying any signatures produced under the stateful signature scheme implemented by the computing devices 202, 204. The trusted entity 206 sends the root public key 216 to the verifier 208. Use of a trusted entity 206 to generate the root public key 216 may reduce complexity for the verifier 208 (since the verifier 208 does not need to generate the root public key 216). However, in some examples, the verifier 208 may itself receive and use the public keys 212, 214 to generate the root public key 216. In some examples, the first and/or second computing device 202, 204 may themselves generate the root public key 216. As described previously, whether or not the seed is shared by the first and second computing devices 202, 204 may affect which entity (i.e., computing devices 202, 204, trusted entity 206 or verifier 208) may be used to generate the root public key 216.

In an example, the second computing device 204 signs data using one of its OTS private keys and then transmits the signed data 218 (which includes both the data and the signature) to the verifier 208. The verifier 208 calculates a candidate OTS public key from the data and the signature and verifies that this candidate public key is linked to the root public key 216 based on the authentication path. In this example, the root public key 216 is sent to the verifier 208. This allows the verifier 208 to use the authentication path to verify the candidate public key is in the Merkle tree with its root as the root public key 216. In some examples, the authentication path is sent to the verifier 208 by the second computing device 204 alongside the signed data 218.

An example implementation for partitioning the state space is described below.

In this example, suppose there are n=2 signers. A generator, which may be one of the two signers, (or an external entity) may generate the private seed value, s, and then consider the state space (i.e., the set of all possible values the state could be). In an example where the height, h, of the Merkle tree is h=10, the state space is X={0, 1, 2, . . . , 2¹⁰−1} and the generator may partition the set space into two subsets, X₁ and X₂. The generator may send subset X₁ to the first signer (unless the generator is the first signer) and subset X₂ to the second signer.

In some examples, the partitioning of the state space may be equal, such as in the following example implementations:

$${X}_{1} = \{ 2 a \vert a = 0 , 1 , … , {2}^{9} - 1 \} ; {X}_{2} = \{ 2 a + 1 \vert a = 0 , 1 , … , {2}^{9} - 1 \} ;$$

$$or$$

$${X}_{1} = \{ 0 , 1 , … , {2}^{9} - 1 \} ; {X}_{2} = \{ {2}^{9} , {2}^{9} + 1 , … , {2}^{10} - 1 \} .$$

In some examples, the partitioning of the state space may be unequal. This may be appropriate if one of the two signers is less likely to fail, and so may be trusted with a higher portion of the state space. An example implementation is:

$${X}_{1} = \{ 0 , 1 , 2 \} ; {X}_{2} = \{ 3 , 4 , 5 , … {2}^{10} - 1 \} .$$

Thus, as the partitioning of the state space is distinct, each OTS private key generated by each signer is distinct. If one signer fails, the other signer still has some keying material corresponding to the deployed public key.

In order to enforce the stateful signature scheme, the signers are to use a state from the state space they have been allocated. The original generator of the seed may not store the private seed value unless it is a signer with an allocated state space itself after sending the private seed where it is needed.

In some examples, the partitioning of the state space may be implemented in a distributive manner instead of by a generator. For example, each signer may be given a rule for which state values it can own. In an example, if there are “n” signers, each signer may number itself (the first online may be numbered as ‘0’, the next as ‘1’ and so on until the last signer, signer n, comes online), and then signer “x” is to take the set of states which equal x mod n. In this manner, each signer can determine the states it is to use based on the rule rather than receiving information directly informing it which states of the state space it is to use.

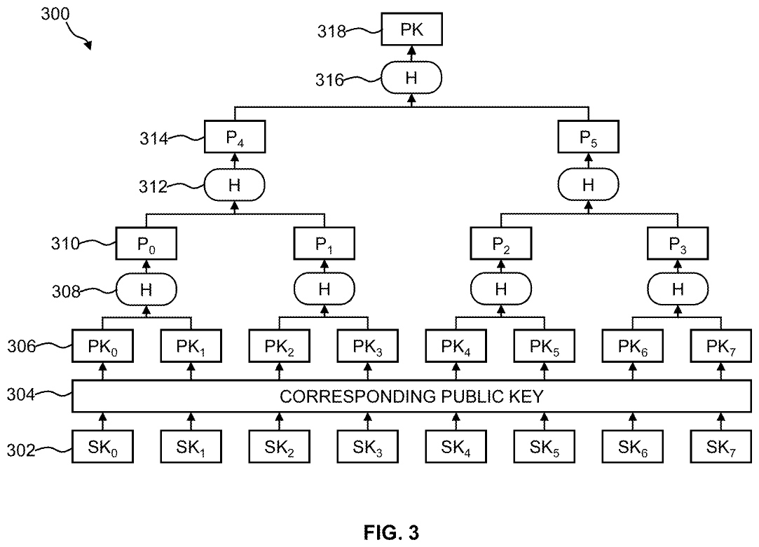

FIG. 3 is a simplified schematic drawing of an example Merkle tree 300 for implementing a stateful hash-based signature scheme.

In this example, the Merkle tree 300 has a height of h=3, which means it has 2³=8 OTS private keys 302 (indicated by blocks “SK₀” through to “SK₇”). That is, there are 8 states in the state space of the stateful hash-based signature scheme and there exists a single corresponding public key 304 which links to all of the 8 states. The signer(s) implementing the stateful hash-based signature scheme generate the OTS private keys 302 and also generate corresponding public keys 306 for each OTS private key 302 (indicated by “PK₀” through to “PK₇”). The OTS private keys 302 may be considered to occupy a set of elements (i.e., “leaf positions” or “nodes”) in a first tier of the Merkle tree 300. Each pair of public keys 306 may be combined and hashed at blocks 308 (indicated by the label “H”) to form an intermediate public key 310 (labelled “P₀” through to “P₃”). Each pair of these intermediate public keys 310 may be combined and hashed at blocks 312 (indicated by the label “H”) to form an additional intermediate public key 314 (labelled “P₄” and “P₅”). The pair of the additional intermediate public keys 314 may be combined and hashed at block 316 (indicated by the label “H”) to form a root public key 318 (labelled “PK”), which corresponds to the single public key 304 linking to all of the states of the stateful hash-based signature scheme. The intermediate public keys 310, 314 and root public key 318 represent other tiers of the Merkel tree 300 where the intermediate public keys 310, 314 and root public key 318 occupy elements (i.e., leaf positions/nodes) in a higher tier (than the first tier) of the Merkle tree 300. An element in any tier higher than the first tier is a root element linked to certain elements in the first tier. For example, P₄ is a root element linked to “SK₀” through to “SK₃” (and P₄ is in a higher tier than the OTS private keys 302). Similarly, P₅ is a root element linked to “SK₄” through to “SK₇”. The root public key PK 318 occupies the highest tier of the Merkle tree and is linked to all of the OTS private keys 302 derived from the state space.

In an example, suppose a signer under the stateful hash-based signature scheme constructs part of the Merkle tree 300 corresponding to the branch comprising SK₀ through to SK₃. The signer outputs the public key 310 (P₄). Supposing another signer constructs the remaining part of the Merkle tree corresponding to the branch comprising SK₄ through to SK₇. This other signer outputs the public key 310 (P₅). A verifier attempting to verify a message signed using SK₀ may use a root public key (PK) that is derived (e.g., by a trusted entity and sent to the verifier as depicted by FIG. 2) from P₄ and P₅ to verify that the signed message was produced by the signer. In this regard, the verifier uses the signature and the message to compute a candidate public key (for PK₀). The verifier then uses their candidate public key plus the authentication path (i.e., PK₁, P₁ and P₅) to compute the root node and if this is same as the root public key (PK), the candidate public key is in the Merkle tree with the root public key (PK) as its root.

Some examples relating to the above are now described.

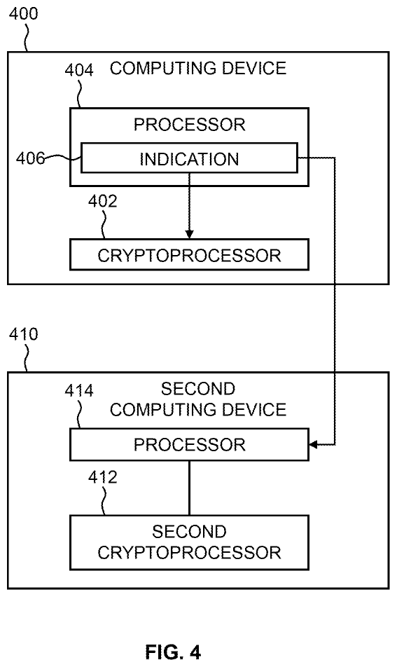

FIG. 4 is a simplified schematic drawing of example first and second computing devices 400, 410 for implementing a stateful signature scheme. Reference numerals for features that are similar to or have corresponding functionality to features of the computing device 100 of FIG. 1 are incremented by 300. Further functionality of the computing devices 400, 410 is described with reference to certain other examples also described above.

Similar to FIG. 1, the first computing device 400 comprises a processor 404. In this example, the first computing device 400 further comprises a cryptoprocessor 402 communicatively coupled to the processor 404. The processor 404 is to provide an indication 406 to the cryptoprocessor 402 similar to the manner described in relation to FIG. 1 or its related examples.

The second computing device 410 is distinct from the first computing device 400 and therefore any references to features of the second computing device 410 are for distinguishing such features from those of the (first) computing device 400. The second computing device 410 comprises a (second) cryptoprocessor 412 and a (second) processor 414. Similar to the computing device 100, the second processor 414 may be implemented by the second cryptoprocessor 412 itself, or they may be separate entities on the same platform. That is, the second computing device 410 may implement the functionality of a signer, where the second cryptoprocessor 412 implements the signing functionality.

In some examples, the processor 404 of the computing device 400 is to identify a second partition in the state space for implementation by the second cryptoprocessor 412. The processor 404 is further to transmit, to the second computing device 410, an indication 406 of the second partition. For example, the second processor 414 may receive the indication 406 and instruct the second cryptoprocessor 412 to implement the stateful signature scheme based on the partition of the state space assigned to the second computing device 410. In some examples, the second processor 414 may be implemented by the second cryptoprocessor 412 such that the indication 406 may be received (and implemented) by the second cryptoprocessor 412.

As mentioned previously, the indication 406 may be a rule (such as “x mod n”) or some other information such as index values assigned to each computing device 400, 410 to allow each computing device 400, 410 to generate, via its cryptoprocessor 402, 412, its own set of OTS private keys.

In some examples, the state space is indicative of (i.e., can be used to derive) a set of one-time use private keys (i.e., OTS private keys) for signing data (e.g., for the entire state space of the stateful signature scheme). The partition (assigned to the computing device 400) is associated with a first subset (e.g., X₁) of the set of one-time use private keys. The second partition is associated with a second subset (e.g., X₂) of the set (X₁ plus X₂). The second subset is distinct from the first subset (e.g., if each subset is indicated by a corresponding subset of index values, none of the index values are repeated across the two subsets).

This example may be extended to any number of signers (e.g., there may be three or more partitions of the state space).

In some examples, the cryptoprocessor 402, 412 comprises a hardware security module (HSM). In some examples, the functionality of the computing device 400, 410 is implemented by such an HSM. The HSM is to destroy keying material (e.g., the seed, state information and/or any private keys) stored therein in response to detecting an unauthorized attempt to access the HSM.

In some examples, the indication 406 comprises a rule executable by the cryptoprocessor 402 (and the second cryptoprocessor 412) to allow the cryptoprocessor 402 (and the second cryptoprocessor 412) to determine an unused private key (e.g., a private key that is not likely for the second cryptoprocessor 412 to generate itself) for signing data. The unused private key is derivable from a state of the partition. For example, the rule “x mod n” may be indicated along with the values “x” and “n” so that the processor 404 may determine the state space, which may then be used to derive the set of one-time use private keys available to the cryptoprocessor 402 (and hence also the cryptoprocessor 412). In some examples, the cryptoprocessors 402, 412 may implement their own logic such as a counter to ensure that they do not re-use any of their own one-time use private keys.

Although not indicated by FIG. 4, a common seed may be made available to each of the cryptoprocessors 402, 412 (e.g., using any of the examples described herein) so that they can derive their one-time use private keys.

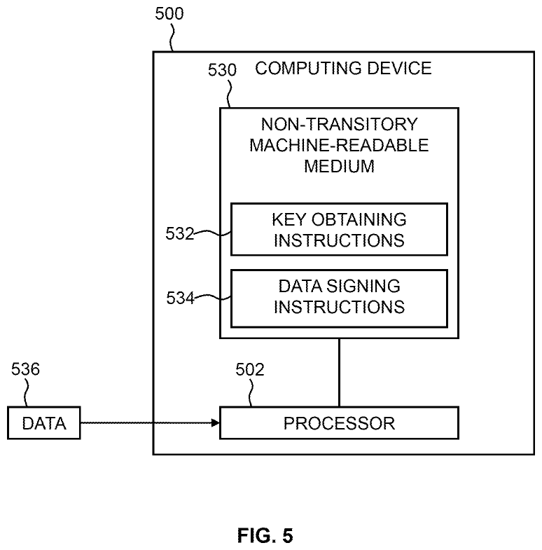

FIG. 5 is a simplified schematic drawing of an example computing device 500 for implementing a stateful signature scheme. Reference numerals for features that are similar to or have corresponding functionality to features of the computing device 100 of FIG. 1 are incremented by 400. Certain functionality of the computing device 500 is described with reference to certain other examples also described above. In some examples, the computing device 500 implements the same or similar functionality to other computing devices described herein. In this regard, the computing device 500 implements the functionality of a signer.

The computing device 500 comprises a non-transitory machine-readable medium 530 storing instructions readable and executable by a processor 502 of the computing device 500. In some examples, the processor 502 implements functionality of a cryptoprocessor such as described elsewhere herein.

As used herein, the term “non-transitory” does not encompass transitory propagating signals.

The instructions comprise key obtaining instructions 532 to obtain a one-time use private key (e.g., an OTS private key) derived from a state of a portion (where the meaning of the term “portion” may correspond to the meaning of the term “partition” used elsewhere herein) of a state space. The state space is assigned to the computing device 500 as part of a stateful signature scheme. In some examples, the computing device 500 may itself determine its assigned portion of the state space (e.g., in the manner described in relation to the computing device 100 of FIG. 1). In some examples, the computing device 500 may receive an indication of its assigned portion of the state space (e.g., in the manner described in relation to the second computing device 410 of FIG. 4).

The instructions further comprise data signing instructions 534 to sign data 536 using the private key.

The computing device 500 provides the functionality of a signer, as described previously. For example, by using the portion of the state space assigned to the computing device 500, key resiliency may be maintained while reducing the risk of state reuse and/or reducing the compute resources needed to verify (e.g., a single OTS signature may be quick to verify).

In some examples, the processor 502 is to wipe a parameter (e.g., a security parameter such as a cryptographic key, authentication data, state space indication, etc.) stored therein in response to a determination being made that the computing device 500 has been compromised (e.g., by a physical attack). For example, the computing device 500 may implement the functionality of an HSM, which may implement a level of security similar to that specified by a standard such as FIPS Publications 140-2 or 140-3.

In some examples, the data 536 comprises a digest of a message such as code (e.g., for implementing an update) to be sent to user devices by computing infrastructure hosting the computing device 500. In some examples, the digest is generated by a hashing function such as specified by Secure Hash Algorithm 1 or 2 (SHA-1 or SHA-2). In some examples, a first part of the procedure for signing the message comprises computing a (randomized) hash of the (possibly large) message to generate the digest. Upon the signing procedure being completed, the computing infrastructure may send the (signed) message to the user devices, which may allow the user devices to verify the message is authentic (e.g., it originated from a trusted source) so that the user devices may proceed to implement the update according to the code.

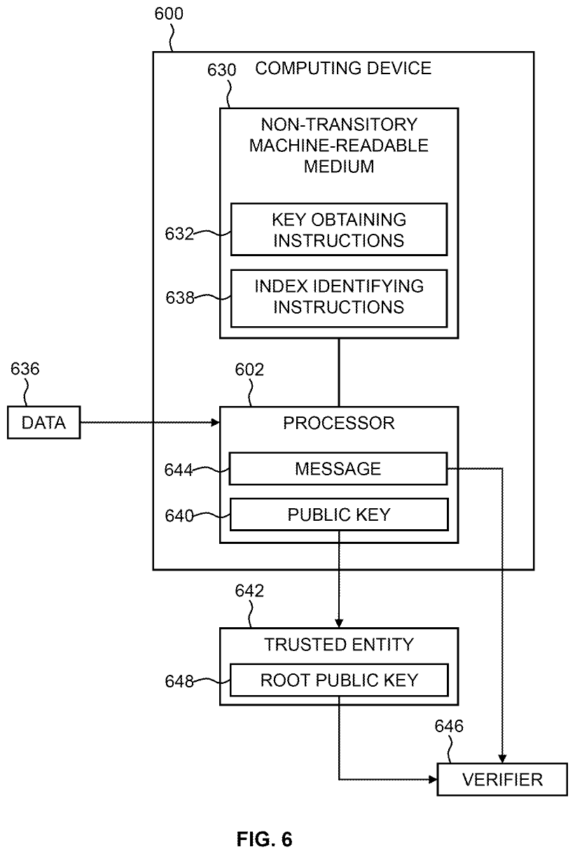

FIG. 6 is a simplified schematic drawing of an example computing device 600 for implementing a stateful signature scheme. Reference numerals for features that are similar to or have corresponding functionality to features of the computing device 500 of FIG. 5 are incremented by 100. In this regard, the computing device 600 implements the same functionality as the computing device 500 and further functionality as described below.

The computing device 600 comprises a non-transitory machine-readable medium 630 storing instructions readable and executable by a processor 602 of the computing device 600. Since the computing device 600 implements the same functionality as the computing device 500, the instructions of the computing device 600 comprise the same instructions as the computing device 500. A description of further functionality of the key obtaining instructions 632 is provided below. In some examples, the instructions further comprise index identifying instructions 638.

In some examples, the key obtaining instructions 632 instruct the processor 602 to input a seed and an index value (both of which are described previously) corresponding to the state into a key generator (e.g., implemented by the processor 602) to generate the one-time use private key (e.g., an OTS private key). In some examples, the key generator is to generate the one-time use private key using a pseudorandom function (PRF).

In some examples, the key obtaining instructions 632 instruct the processor 602 to generate a set of one-time use private keys derived from a corresponding set of states of the portion of the state space. The set of one-time use private keys comprises the one-time use private key used to sign the data.

The key obtaining instructions 632 are further to instruct the processor 602 to generate a public key 640 based on the set of one-time use private keys (i.e., the one-time use private keys associated derived from the states in the portion of the state space assigned to the computing device 600). For example, with reference to FIG. 3, the set of one-time use private keys occupy a set of elements (e.g., but not all elements) in a first tier of a Merkle tree 300. The public key 640 occupies an element in a second tier of the Merkle tree 300. The public key 640 corresponds to an intermediate public key, as described previously. The element in the second tier may therefore correspond to an intermediate public key linked to each of the set of elements (i.e., the set of one-time use private keys) in the first tier.

In some examples, the key obtaining instructions 632 are further to instruct the processor 602 to store information for re-obtaining the set of private keys. The information may be stored in a memory (not shown) of the computing device 600. In some examples, the information may be the set of private keys as generated (so that they can be retrieved from the memory when needed). In some examples, the information may comprise the seed (so that the set of private keys can be re-generated from the seed and the states).

The key obtaining instructions 632 are further to instruct the processor 602 to transmit the public key 640 to a trusted entity 642. For example, once the set of private keys has been generated along with the corresponding public key 640, the public key 640 may be transmitted. In use of the computing device 600, data 636 may be signed by the processor 602 and the resulting signed message 644 (i.e., the data plus the signature) may be transmitted to a verifier 646 so the verifier 646 can use the signed message 644 to compute a candidate public key which can then be used along with the authentication path, facilitated by the trusted entity 642, to verify whether the candidate public key is associated with the root public key 648. If so, the signature on the data is accepted as genuine and the message is therefore authentic. The authentication path does not necessarily include public keys from all the other signers as described in some examples, i.e., the public keys associated with the other signers may or may not be in the authentication path. In some examples, the authentication path consists of the nodes in the Merkle tree that enable the verifier 646 to compute the root public key 648 from their candidate public key. This is independent of whether or not the nodes are intermediate public keys produced by different signers.

In some examples, key obtaining instructions 632 are to instruct the processor 602 to implement a key generator to generate the set of private keys. Each private key may be derived from a seed and an index value for identifying the state associated with the private key.

In examples described previously, each private key is generated from a seed (e.g., one_time_private_key=f(seed, i), where “I” is the state), where the function “f” may implement a PRF and/or a key derivation function (KDF) such as a hash-based message authentication code (HMAC)-based KDF (HKDF). However, any appropriate pseudorandom method be implemented to generate the OTS private keys from the seed and the state.

In some examples, the set of private keys may be all randomly generated independently. That is, there may not be a common seed used to generate the set of private keys.

In some examples, the set of private keys may be independent between the different signers, but dependent on a common seed per signer (i.e., instead of every OTS private key being generated independently). In some examples, a first signer has a common/independent seed which is used to generate its set of OTS private keys using a KDF. A second signer has a different, common/independent seed which is used to generate all OTS private keys associated with the second signer.

In some examples, the portion of the state space comprises a set of index values for identifying a corresponding set of private keys available to the processor 602 (e.g., when needed to sign received data). In this regard, the index identifying instructions 638 are to instruct the processor 602 to use a function (e.g., a counter) to identify an index value within the set of index values that is associated with an unused private key in the set of private keys. The index identifying instructions 638 are further to instruct the processor 602 to use the index value to obtain the private key (e.g., via the key obtaining instructions 632) for signing the data 636. In some examples, the private key for signing the data 636 may be obtained by re-generation, as described previously. In some examples, the private key for signing the data 636 may be obtained by retrieval from memory of the computing device 600.

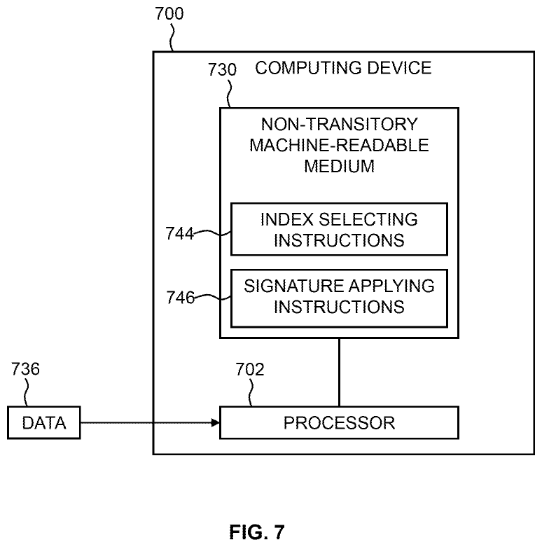

FIG. 7 is a simplified schematic drawing of an example computing device 700 for implementing a stateful signature scheme. Reference numerals for features that are similar to or have corresponding functionality to features of the computing device 500 of FIG. 5 are incremented by 200. Thus, the computing device 700 implements a similar function to the computing device 500 and related examples (i.e., the computing device 700 implements the functionality of a signer).

The computing device 700 comprises a non-transitory machine-readable medium 730 storing instructions readable and executable by a processor 702 of the computing device 700. The processor 702 implements functionality of a cryptoprocessor/signer such as described elsewhere herein.

The instructions comprise index selecting instructions 744 and signature applying instructions 746.

The index selecting instructions 744 are to instruct the processor 702 to select an unused index value from a set of index values allocated to the computing device 700 as part (where the meaning of the term “part” may correspond to the meaning of the terms “partition” or “portion” used elsewhere herein) of a state space. The state space is used in a stateful signature scheme. The set of index values identify a corresponding set of private keys generated by the computing device 700.

The signature applying instructions 746 are to instruct the processor 702 to apply a signature to data 736 using a private key identified by the unused index value.

In some examples, the unused index value may be selected by a counter function, or other appropriate function, to ensure that any index value for generating a private key that goes on to be used to sign data 736 is not used again and/or the private key is not used again.

In some examples, the computing device 700 may provide the functionality of a signer, as described previously. For example, by using the part of the state space allocated to the computing device 500, key resiliency may be maintained while reducing the risk of state reuse and/or reducing the compute resources needed to verify (e.g., a single OTS signature may be quick to verify).

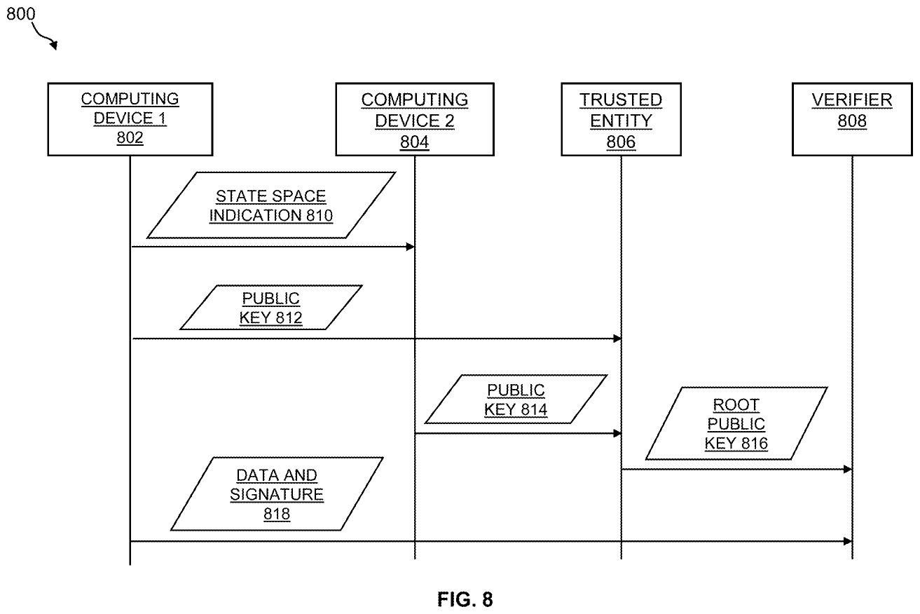

FIG. 8 is a flowchart of an example method 800 of implementing a stateful signature scheme. In some examples, a part of the method 800 may be implemented by the computing device 800 or other computing devices or machine-readable media described herein. The flowchart depicts an interaction between a first computing device (computing device 1) 802, a second computing device (computing device 2) 804, a trusted entity 806 and a verifier 808. In some examples, the first computing device 802 implements an extension to the functionality of the computing device 700 of FIG. 7 and related computing devices. The method 800 has similarities to the method 200 but with the differences described below.

As described above, certain examples described herein provide resiliency of a private seed value, which is the same seed value used by a set of signers. However, there may be a need for each signer to generate their own key/private seed value, rather than one entity generating the seed and distributing it to the signers as described previously. While the previously described examples manage the risk of copying the private seed value by partitioning the state space and ensuring the private key does not exist outside of the signers, the following examples may extend these examples so that each signer generates their own key/private seed value, which may reduce the risk of distributing a private seed value and may adhere to a standard such as specified by National Institute of Standards and Technology (NIST). In an example, a plurality of signers may all agree on some parameters that have to be constant for an entire Merkle tree (e.g., the parameter “I” in the LMS scheme, which is used as a prefix for certain hash computations). Each signer may each generate their own private seed, generate all their OTS keys and associated public keys, and compute their portion of the Merkle tree. Then, by combining (i.e., hashing) the output of these associated public keys, a root public key may be generated by a trusted entity (or the root public key could be generated by the signer or a verifier) that could be used by a verifier as described herein. In this case, it would not be possible for one signer to use the state space of another signer as it would not have the correct private seed.

In the method 800, a state space indication 810 (e.g., that provides a similar function as the indication 106) is transmitted by the first computing device 802 to the second computing device 804. In this manner, each of the computing devices 802, 804 establish which partition of the state space they are to use. Each computing device 802 is assigned a “power of two” number of states in its partition. In other words, each computing device 802, 804 is assigned a set of 2^{b}^{ᵢ} consecutive states, for i={1, n} (where n is the number of computing devices).

However, the private seed value is not distributed or collaboratively determined as described in previous examples. Instead, the first and second computing devices 802, 804 determine their own private seed values (e.g., the private seed may be randomly generated by the respective computing device 802, 804).

Each computing device 802, 804 can then compute the highest element of the Merkle tree that corresponds to their part of the state space. The highest element of the Merkle tree refers to the highest possible tier of the Merkle tree that is linked to each state associated with the respective computing device 802, 804 used to generate the public key. Each public key output in a tier of the Merkle tree other than the lowest or highest tier can be referred to as an intermediate public key. The public keys corresponding to their respective highest elements of the Merkle tree are output by the respective computing devices 802, 804, thereby allowing the trusted entity 806 to compute the root of the Merkle tree, which becomes the root public key (“PK”) 816 for the overall system. The trusted entity 806 could be an intermediate device between the computing devices 802, 804 and the verifier 808. An example implementation is where each computing device 802, 804 outputs its respective public key 812, 814 corresponding to the respective highest elements of the Merkle tree. These public keys 812, 814 are received by the trusted entity 806, which combines these keys 812, 814 together (e.g., by hashing the combination) to generate PK 816. During signature verification, the verifier 808 may access PK 816 via the trusted entity 806 (which may send PK 816 to the verifier 808) in order to perform signature verification (e.g., based on the LMS signature verification scheme). As such, the management of the state space is hidden to the verifier 808. Using a trusted entity 806 to compute PK 816 instead of the verifier 808 may reduce vulnerabilities since the verifier 808 may otherwise need to ensure that the intermediate public keys are trusted. In some examples, the trusted entity 806 may comprise the signer (e.g., one of the computing devices 802, 804). For example, there may be secure communication between the computing devices 802, 804 (where each computing device 802, 804 may be a signer). However, one of the computing devices 802, 804 may implement the functionality of the trusted entity 806.

Some example implementations are now described with reference to FIG. 3, which shows a Merkle tree 300 of height h=3, meaning the state space consists of 23 elements {0, . . . , 7}.

In an example with n=2 signers, the state space could be split such that X₁={0, 1, 2, 3}; X₂={4, 5, 6, 7} (i.e., b₁=2=; b₂=2). Signer 1 (i.e., the first computing device 802) then generates their own private seed value and uses their state space to then compute the left hand of the tree, outputting P₄ (i.e., public key 812). Signer 2 (i.e., the second computing device 804) then implements a similar procedure, using their own generated private seed value, and outputting P₅ (i.e., public key 814). A trusted entity (e.g., this could be the verifier 808, one of the signers or a third party) receives P₄ and P₅ and uses these to compute PK. The verifier 808 may use PK 816 to verify a signature applied to data (i.e., where the data is signed by the first computing device 802). The resulting data and signature 818 are transmitted to the verifier 808, which uses PK 816 to verify the signature.

In an example with n=3 signers, the state space may be split such that X₁={0,1}; X₂={2,3}; X₃={4,5,6, 7} (i.e., b₁=1; b₂=1; b₃=2). Signer 1 then produces their own private seed value and outputs P0. Similarly, signer 2 outputs P1 and signer 3 outputs P5. From P0, P1 and P5, a trusted entity could then compute PK.

In some examples, the entity that computes PK from the Merkle tree nodes output by the signers authenticates the signers prior to computing PK, so as not to have malicious nodes in the Merkle tree 300.

Some examples relating to the extension are now described.

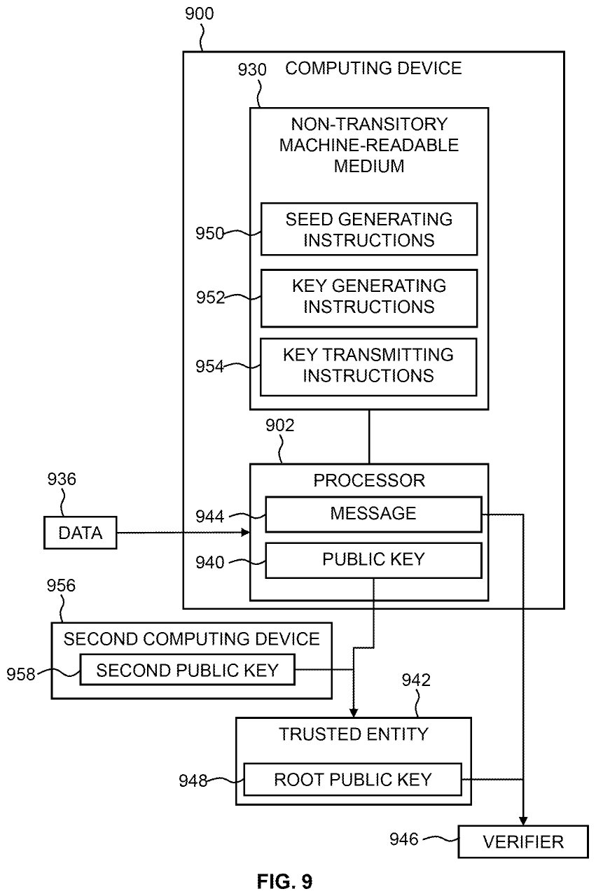

FIG. 9 is a simplified schematic drawing of an example computing device 900 for implementing a stateful signature scheme. Reference numerals for features that are similar to or have corresponding functionality to features of the computing device 700 of FIG. 7 are incremented by 200. In this regard, the computing device 900 implements the same functionality as the computing device 700 and further functionality as described below.

The computing device 900 comprises a non-transitory machine-readable medium 930 storing instructions readable and executable by a processor 902 of the computing device 900. Since the computing device 900 implements the same functionality as the computing device 700, the instructions of the computing device 900 comprise the same instructions as the computing device 700. In addition, in some examples, the instructions further comprise seed generating instructions 950. In some examples, the instructions further comprise key generating instructions 952. In some examples, the instructions further comprise key transmitting instructions 954.

In some examples, data 936 is signed by the processor 902 and the resultant data and signature (i.e., message 944) is transmitted to a verifier 946. A public key 940 (i.e., the public key 812) is transmitted to a trusted entity 942 (e.g., prior to or after the message 944 is transmitted).

In some examples, a second computing device 956 (which implements similar functionality to the computing device 900 but uses a different partition of the state space under the same stateful signature scheme) transmits its public key 958 (i.e., the second public key 814) to the trusted entity 942.

In some examples, the seed generating instructions 950 are to instruct the processor 902 to generate a seed that is private to the computing device 900.

In some examples, the key generating instructions 952 are to instruct the processor 902 to generate the set of private keys using a pseudorandom function applied to the seed and the set of index values. The key generating instructions 952 are further to instruct the processor 902 to generate a public key for each private key using a one-way function. In some examples, the one-way function is to generate a hash chain derived from the private key.

In some examples, the key generating instructions 952 are to instruct the processor 902 to generate a public key for the part of the state space corresponding to the set of index values. The public key is derived from the set of private keys generated by the computing device 900. For example, the public key could be derived by hashing together the different public keys at the Merkle tree elements associated with the partitioned state space, as described in relation to FIG. 3.

In some examples, the key transmitting instructions 954 are to instruct the processor 902 to transmit the public key 940 to the trusted entity 942. The trusted entity 942 is to combine the public key 940 with a second public key 958 to form a root public key 948 for the state space. The second public key 958 is derived from a second set of private keys. The second set of private keys is generated by the second computing device 956. The second set of private keys is associated with a second part of the state space.

In some examples, the public key 940 is generated at a first leaf position on a Merkle tree. The Merkle tree is associated with the part of the state space associated with the computing device 900. The second public key 958 is generated at a second leaf position on the Merkle tree associated with the second part of the state space. The public key 940 and the second public key 958 are useable to derive the root public key 948 of the Merkle tree.

In some examples, the stateful signature scheme is a stateful hash-based signature scheme.

Any of the blocks, nodes, instructions or modules described in relation to the figures may be combined with, implement the functionality of or replace any of the blocks, nodes, instructions or modules described in relation to any other of the figures. For example, methods may be implemented as machine-readable media or computing devices, machine-readable media may be implemented as methods or computing devices, and computing devices may be implemented as machine-readable media or methods. Further, any of the functionality described in relation to any one of a method, machine readable medium or computing device described herein may be implemented in any other one of the method, machine readable medium or computing device described herein. Any claims written in single dependent form may be re-written, where appropriate, in multiple dependency form since the various examples described herein may be combined with each other.

Examples in the present disclosure can be provided as methods, systems or as a combination of machine-readable instructions and processing circuitry. Such machine-readable instructions may be included on a non-transitory machine (for example, computer) readable storage medium (including but not limited to disc storage, CD-ROM, optical storage, flash storage, etc.) having computer readable program codes therein or thereon.

The present disclosure is described with reference to flow charts and block diagrams of the method, devices and systems according to examples of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing circuitry, or a module thereof, may execute the machine-readable instructions. Thus, functional nodes, modules or apparatus of the system and other devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer program product, the computer program product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the scope of the present disclosure. It is intended, therefore, that the method, apparatus and related aspects be limited by the scope of the following claims and their equivalents. It should be noted that the above-mentioned examples illustrate rather than limit what is described herein, and that many implementations may be designed without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A computing device comprising:
a processor to:
identify a partition in a state space of a stateful signature scheme for implementation by a cryptoprocessor; and
provide, to the cryptoprocessor, an indication of the partition.

2. The computing device of claim 1, wherein the processor is to:
identify a second partition in the state space for implementation by a second cryptoprocessor of a second computing device; and
transmit, to the second computing device, an indication of the second partition.

3. The computing device of claim 2, wherein:
the state space is indicative of a set of one-time use private keys for signing data;
the partition is associated with a first subset of the set;
the second partition is associated with a second subset of the set; and
the second subset is distinct from the first subset.

4. The computing device of claim 1, wherein the cryptoprocessor comprises a hardware security module (HSM), and wherein the HSM is to destroy keying material stored therein in response to detecting an unauthorized attempt to access the HSM.

5. The computing device of claim 1, wherein the indication comprises a rule executable by the cryptoprocessor to allow the cryptoprocessor to determine an unused private key for signing data, wherein the unused private key is derivable from a state of the partition.

6. A non-transitory machine-readable medium storing instructions readable and executable by a processor of a computing device to:
obtain a one-time use private key derived from a state of a portion of a state space, wherein the state space is assigned to the computing device as part of a stateful signature scheme; and
sign data using the private key.

7. The non-transitory machine-readable medium of claim 6, wherein the processor is to:
input a seed and an index value corresponding to the state into a key generator to generate the one-time use private key

8. The non-transitory machine-readable medium of claim 6, wherein the processor is to:
generate a set of one-time use private keys derived from a corresponding set of states of the portion of the state space, wherein the set of one-time use private keys comprises the one-time use private key used to sign the data;
generate a public key based on the set of one-time use private keys; and
transmit the public key to a trusted entity.

9. The non-transitory machine-readable medium of claim 8, wherein the processor is to implement a key generator to generate the set of one-time use private keys, wherein each one-time use private key is derived from a seed and an index value for identifying the state associated with the private key.

10. The non-transitory machine-readable medium of claim 6, wherein the portion of the state space comprises a set of index values for identifying a corresponding set of one-time use private keys available to the processor, and wherein processor is to:
use a function to identify an index value within the set of index values that is associated with an unused private key in the set of one-time use private keys; and
use the index value to obtain the one-time use private key for signing the data.

11. A non-transitory machine-readable medium storing instructions readable and executable by a processor of a computing device to:
select an unused index value from a set of index values allocated to the computing device as part of a state space, wherein the state space is used in a stateful signature scheme, and wherein the set of index values identify a corresponding set of private keys generated by the computing device; and
apply a signature to data using a private key identified by the unused index value.

12. The non-transitory machine-readable medium of claim 11, comprising instructions to instruct the processor to:
generate a seed that is private to the computing device;
generate the set of private keys using a pseudorandom function applied to the seed and the set of index values; and
generate a public key for each private key using a one-way function.

13. The non-transitory machine-readable medium of claim 11, comprising instructions to instruct the processor to:
generate a public key for the part of the state space corresponding to the set of index values, wherein the public key is derived from the set of private keys generated by the computing device.

14. The non-transitory machine-readable medium of claim 13, comprising instructions to instruct the processor to:
transmit the public key to a trusted entity, wherein the trusted entity is to combine the public key with a second public key to form a root public key for the state space, wherein the second public key is derived from a second set of private keys, wherein the second set of private keys is generated by a second computing device, and wherein the second set of private keys is associated with a second part of the state space.

15. The non-transitory machine-readable medium of claim 11, wherein the stateful signature scheme is a stateful hash-based signature scheme.
